(19) United States
(12) Patent Application Publication
(10) Pub. No.: US 2017/0049093 A1
(43) Pub. Date: Feb. 23, 2017

(54) Automated System for Filling an Agricultural Sprayer

(71) Applicant: Garrett R. Belden, Groton, SD (US)

(72) Inventor: Garrett R. Belden, Groton, SD (US)

(21) Appl. No.: 14/829,637

(22) Filed: Aug. 19, 2015

(51) Int. Cl. A01M 7/00

(52) U.S. Cl. CPC A01M 7/0092; A01M 7/0042

(57) ABSTRACT

An automated system for loading agricultural chemical application equipment that includes actuated valves and pumps to meter appropriate quantities of chemical. The system includes either a pump or venturi to transfer chemical. The system includes sensors to provide measurements of chemical parameters. A touchscreen user interface allows the user to input chemical selections and quantities. The processing method directs the valves and pumps according to the user inputs and feedback from the sensors.

### BACKGROUND

Field of the Invention

The present invention relates to an automated fill system for agricultural sprayers.

Description of Related Art

The agriculture industry uses chemical application equipment, known as sprayers, to apply chemical blends to fields of crop plants. The sprayers may be self-propelled, pulled by or mounted on a tractor, or aerial application planes or helicopters. These chemicals could be pesticides, herbicides, fertilizers, or other compounds. These sprayers have an on-board tank that holds the mixture of chemicals and water that is to be applied to the field. The on-board tanks are generally in the range of 800 to 2000 gallons and this capacity will generally be enough to cover 40 to 400 acres of crops depending on the application rate. This would generally take somewhere between 30 minutes and 3 hours to apply a full tank at which point the operator will need to refill the sprayer.

The need to refill with large volumes of water and chemical several times throughout the day, many times at a remote location, requires the use of a tender trailer which will hold the necessary quantities of water and chemicals to refill the sprayer multiple times. The tender trailer will have an assortment of hoses, valves, tanks, and pumps that will allow the operator to measure the proper amounts of chemicals, blend the chemical with the appropriate amount of water, and load this mixture onto the sprayer tank for another round of application. This process is usually achieved manually by the operator through the physical operation of valves and activation of pumps. The process of refilling the sprayer with a standard manually operated arrangement will usually take anywhere from 15 to 30 minutes.

### SUMMARY OF THE INVENTION

The proposed invention is an automated system for filling an agricultural sprayer.

### DESCRIPTION OF DRAWINGS

Figure one is a flow chart showing the steps of operation of the control system.

Figure two is a front view of the system showing the preferred embodiment.

Figure three is a process schematic of a possible embodiment.

### DETAILED DESCRIPTION

The proposed invention is an automated system for filling an agricultural sprayer. The invention will allow for the refilling of the sprayer in a much simpler and less operator intensive manner. Instead of turning on individual pumps and operating individual valves the operator can simply select the amounts of each chemical to be added with the operator interface and the system will manipulate the proper combinations of valves, pumps, etc. to blend the selected amount of chemical into the batch.

The invention consists of an interface 1, a processing method 2, sensing instruments 3, and process control devices 4. The interface is the method of controlling the system for the operator. It is how the operator gives the system commands and makes selections. The interface could be, but is not limited to, a touchscreen, keypad, or assortment of switches. The processing method is the method by which the system will take inputs from the sensors and interface and use a program to determine the appropriate outputs to the control devices to obtain the desired chemical ratios. The processing method could be, but is not limited to, a Programmable Logic Controller (PLC), a microcontroller, or a system of relays. The sensing instruments provide the processing method with information that is necessary to the program. The sensing instruments that may be needed could include, but are not limited to, flow meters, flow switches, level switches, level sensors, temperature sensors, load cells or pressure sensors. The process control devices that are used are components that manipulate the physical condition of the system. These devices may include, but are not limited to, actuated valves, solenoid valves, electric pumps, gas pumps, air pumps or relays. The control system could be powered by DC electric power, AC electric power, gas powered generator, or a combination.

The system can be configured to operate in various process methodologies with a number of applicable combinations of components to achieve the blending of the proper amounts of chemicals and water. The system allows the user to input the desired amount of each chemical to be metered through the interface. The system will then manipulate the configuration of components to meter the proper amount of each chemical for the batch. The chemicals may be metered as the sprayer is filled or they may be metered into intermediate induction tanks to be pre-measured before the sprayer is filled. The chemicals may be measured by flow rate, weight, or by volume in an intermediate measuring tank. The system may be configured to operate in many different ways after the amounts of chemicals have been selected. The system may start operating to pre-measure chemicals in between the actual refills of the sprayer or it may not operate until the filling of the sprayer begins. The system may be the method of starting the filling process or the start of the filling process may be the input which activates the system.

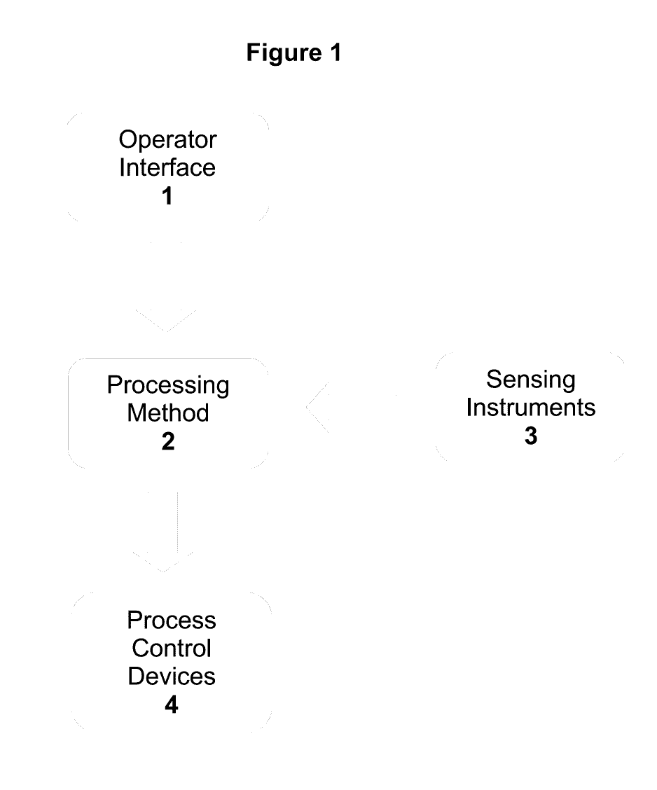

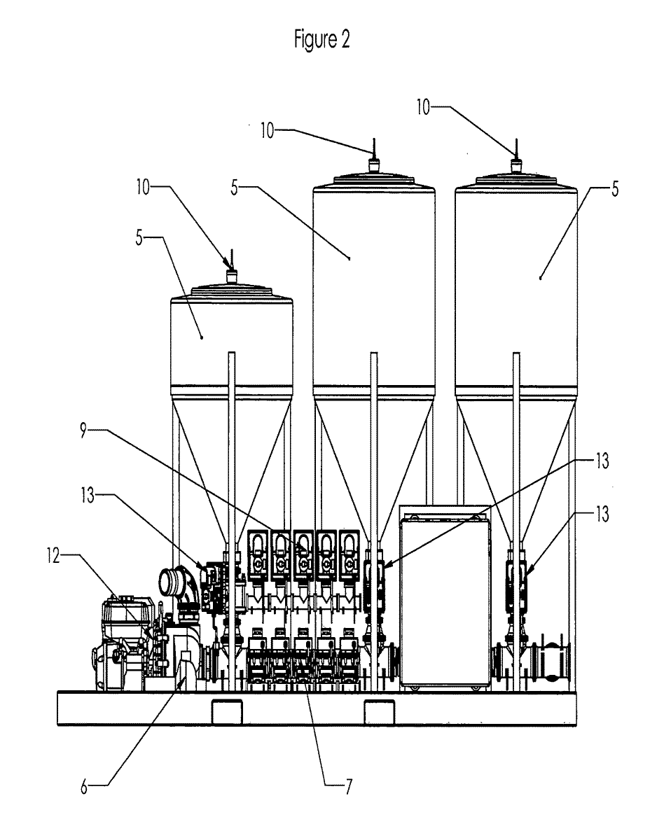

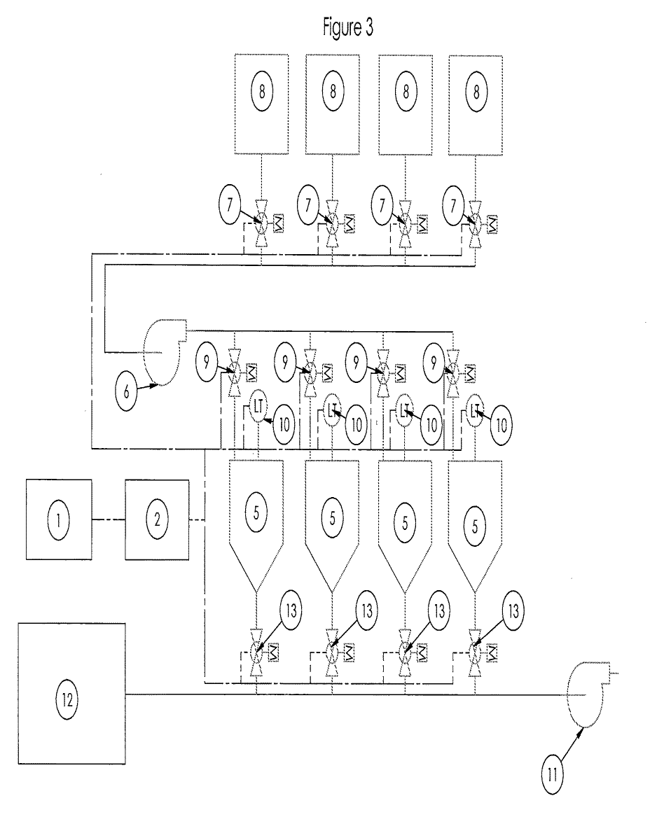

In one aspect of this system, shown in FIG. 1, a possible configuration of the system would be a group of electrically actuated valves that are manipulated by the processor to fill intermediate measuring tanks 5 to a specified level using an electric transfer pump 6. This configuration might have a group of valves 7 on a manifold on the suction side of the transfer pump. This group of valves would be used to select which source 8 the chemical being pumped is coming from. This configuration would also have a group of valves 9 on a manifold on the pressure side of the transfer pump which would determine which intermediate measuring tank the transfer pump is currently pumping into. In this configuration the operating method could be that when the system is started a valve is opened on the suction side of the pump to select which chemical will be filled. At the same time a valve is opened on the pressure side of the pump to select which tank that chemical will be pumped into. The pump is then activated and the selected chemical is pumped into the selected tank and monitored by a level sensor 10. When the appropriate amount of chemical is pumped into the tank the system will stop the pump and close the valves. The system will then repeat this process with the next chemical to be metered and so on until all chemicals for the specific batch are measured and ready to be inducted into the sprayer as it is filled. When the sprayer returns to the tender to refill, the system would be activated by a flow switch on the main water filling hose when the main water transfer pump 11 is started, beginning the flow of water or water based solution from the main water tank 12. The system will then open each induction valve 13 at the appropriate time during the fill, inducting each of the previously measured chemicals into the sprayer with the required amount of water.

In another embodiment of this system, a possible configuration could use a 12 volt transfer pump or a venturi to transfer the chemical directly into the solution being pumped into the sprayer as the fill is happening. This configuration would not require intermediate tanks to measure the chemical, instead the chemical would be measured with either load cells to monitor the weight change in the chemical source or with inline flow meters as the chemical flows from the source to the batch. The operation of this system would be to start the system at the time that the refill of the sprayer begins. The system will then open the appropriate valve to select the chemical source and meter in the chemical until the appropriate amount has been reached. The system would then close that valve and open the valve for the next chemical that is to be metered and continue this cycle until all chemicals for the batch have been metered into the batch. This would happen during the filling of the sprayer.

In yet another embodiment of the system, a transfer pump with a motor that is electric, hydraulic, or air powered could be used to load chemicals into an intermediate measurement tank. In this embodiment all of the chemicals could be metered into one intermediate tank creating a solution of all the chemical to be loaded onto the sprayer. The method of measurement in this embodiment could be load cells to measure mass of the chemical or a flow meter to measure mass or volume flow rates. Claims

1. A system for taking a user input and controlling a system of valves and pumps to meter the specified quantities of agricultural chemicals when filling the tank of an agricultural sprayer.

2. A system according to claim 1, having an operator interface for the user to enter desired quantities of agricultural chemicals to be loaded onto the sprayer.

3. A system according to claim 1, having a method of manipulating valves and pumps to meter the users requested quantities of chemical without further input from the operator.

4. A system according to claim 1, using intermediate holding tanks with feedback sensors for the measurement of agricultural chemicals.

5. A system according to claim 1, having a chemical transfer pump with one manifold of controlled valves on the suction side for selection of the source of the chemical to be transferred and one manifold of controlled valves on the pressure side for selection of the destination of the selected chemical.

6. A system according to claim 1, being mounted on a truck or trailer for mobile use.

7. A system according to claim 1, being mounted in a stationary location such as a loading dock or a shed.

8. A system for filling an agricultural sprayer which includes apparatus for receiving feedback on system conditions, including but not limited to levels, pressures, and flows.

9. A system according to claim 8, having a programmed feature to rinse each tank containing chemical each time the chemical is inducted

10. A system according to claim 8, having the capability to run programmed cleaning cycles which are tailored to the chemical that is being cleaned from the system.

11. A system according to claim 8, having the ability to receive instruction remotely.

12. A system according to claim 8, having the capability to keep a data record of operations for inventory and accountability purposes.

13. A system according to claim 8, having the capability to override individual component operation for manual control in the event of a system malfunction

14. A system according to claim 8, having a failsafe condition where the system will go to a condition that stops the process if a sensor reading is lost, power is lost, a component malfunctions or if any tanks becomes filled to capacity.

15. A system according to claim 8, having a manifold of controlled valves for the selection of the chemical source, a flow meter for chemical quantity measurement, and a venturi to provide suction to move the chemical and induct it into the flow being transferred to the sprayer.

16. A system according to claim 8, having the capability to visually verify all quantities of chemical before they are loaded onto the sprayer.

17. A system according to claim 8, using level sensors for the measurement of chemical quantities.

18. A system according to claim 8, using load cells for measurement of chemical quantities by mass.

19. A system according to claim 8, having the ability to be powered by DC power from a truck or tractor, AC power from a stationary power grid or generator, gasoline engine powered, hydraulic or PTO power, or compressed air powered.
